(19) United States
(12) Patent Application Publication
(10) Pub. No.: US 2023/0322151 A1
(43) Pub. Date: Oct. 12, 2023

(54) ADVANCED LIGHT PROFILE SELECTION FOR A MINING VEHICLE

(71) Applicant: SANDVIK MINING AND CONSTRUCTION OY, Tampere (FI)

(72) Inventor: Seppo NURMI, Tampere (FI)

(21) Appl. No.: 18/025,536

(22) PCT Filed: Sep. 15, 2020
(86) PCT No.: PCT/EP2020/075786

§ 371 Date: Mar. 9, 2023

(51) Int. Cl. B60Q 1/076; B60K 35/00; B60Q 1/00; B60Q 1/14; H05B 47/17; B60Q 1/22

(52) U.S. Cl. CPC B60Q 1/076; B60K 35/00; B60Q 1/0076; B60Q 1/1415; H05B 47/17; B60Q 1/22; B60K 2370/152; B60K 2370/164; B60K 2370/171

(57) ABSTRACT

Various example embodiments relating to customizing a light profile of a mining vehicle are provided. A user may select which lights of the mining vehicle are activated in different light modes of the mining vehicle. In an embodiment, the user may switch between two or more light profiles. Apparatuses, methods, and computer programs are also provided.

### TECHNICAL FIELD

Various example embodiments generally relate to the field of mining vehicles. In particular, some example embodiments relate to controlling lights of the mining vehicles based on user preferences and mining site conditions by a user.

### BACKGROUND

Light functions of mining vehicles are typically constant features which are operated from switches of the mining vehicle. For example, a user of the mining vehicle can manually switch on different light modes such as work lights, low beams or high beams. Further, reversing lights of the mining vehicle are automatically switched on when a reverse gear is selected. The different light modes comprise activation of different sets of lights as set at a factory. Hence, the user is able to actuate different lights by switching between the predetermined light modes.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments provide advanced light control for mining vehicles, where a user of the mining vehicle is able to modify which lights are activated on different light modes of the mining vehicle. In an embodiment, the user is able to switch between two or more light profiles such that a single light mode may cause activation of different sets of lights depending on the selected light profile. These benefits may be achieved by the features of the independent claims. Further implementation forms are provided in the dependent claims, the description, and the drawings.

According to a first aspect, an apparatus for controlling lights of a mining vehicle is provided. The apparatus is configured to determine a customized light profile based on user inputs, the light profile indicating which lights of the mining vehicle are to be activated in each different light mode of a plurality of light modes of the mining vehicle; determine which light mode of the plurality of light modes is to be activated based on a signal received from at least one light mode switch of the mining vehicle; and control the lights of the mining vehicle based on the light mode in accordance with the customized light profile.

In an embodiment, the apparatus is configured to store a plurality of light profiles comprising at least one customized light profile; cause display of a list of the plurality of light profiles to a user; obtain an input from the user indicating a selected light profile from the list of the plurality of light profiles; and control the lights of the mining vehicle based on the light mode in accordance with the selected light profile.

In an embodiment, in addition or alternatively, the customized light profile is associated to a specific user or a user group; and wherein the lights of the mining vehicle are controlled in accordance with the customized light profile associated to the user or user group in response to obtaining an identification of the user or user group.

In an embodiment, in addition or alternatively, the apparatus is further configured to cause display of at least one layout of the lights of the mining vehicle to the user; and wherein the customized light profile is determined based on the user inputs indicating one or more lights from the layout to be activated in one or more light modes of the plurality of light modes.

In an embodiment, in addition or alternatively, the at least one light mode switch comprises a work light mode switch, a low beams light mode switch, a high beams light mode switch and a reversing light mode switch of the mining vehicle.

In an embodiment, in addition or alternatively, the apparatus is configured to set at least one fixed light selection associated to at least one light mode of the plurality of light modes to the customized light profile.

In an embodiment, in addition or alternatively, the lights of the mining vehicle comprises a plurality of light groups, and selection of one light in the light group for the customized light profile causes selection of each light in the light group to be activated in the associated light mode.

According to a second aspect, there is provided a mining vehicle comprising the apparatus of the first aspect.

According to a third aspect, there is provided a method for controlling lights of a mining vehicle. The method comprises determining a light profile based on user inputs, the light profile indicating which lights of the mining vehicle are activated in different light modes of a plurality of light modes of the mining vehicle; determining which light mode of the plurality of light modes is to be activated based on a signal received from at least one light mode switch of the mining vehicle; and controlling the lights of the mining vehicle based on the light mode in accordance with the customized light profile.

In an embodiment, in addition or alternatively, the method comprises storing a plurality of light profiles comprising at least one customized light profile; causing display of a list of the plurality of light profiles to a user; obtaining an indication of a selected light profile from the list of the plurality of light profiles based on an input from the user; and controlling the lights of the mining vehicle based on the light mode in accordance with the selected light profile.

In an embodiment, in addition or alternatively, the customized light profile is associated to a specific user or a user group; and wherein the lights of the mining vehicle are controlled in accordance with the customized light profile associated to the user or user group in response to obtaining an identification of the user or user group.

In an embodiment, in addition or alternatively, the method comprises causing display of at least one layout of the lights of the mining vehicle to the user; and wherein the customized light profile is determined based on the user inputs indicating one or more lights from the layout to be activated in one or more light modes of the plurality of light modes.

In an embodiment, in addition or alternatively, the method comprises setting at least one fixed light selection associated to at least one light mode of the plurality of light modes to the customized light profile.

According to a fourth aspect, a computer program is provided, the computer program comprising program code configured to cause performance of the method according to the third aspect, when the computer program is executed on a computer.

According to a fifth aspect, a computer readable medium comprising the computer program of the fourth aspect is provided.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments. In the drawings:

FIG. 1 illustrates an example of a block diagram of a mining vehicle configured to control lights of the mining vehicle based on a light profile and a light mode selected by a user, according to an example embodiment.

FIG. 2 illustrates an example of an apparatus configured to practice one or more example embodiments.

FIGS. 3A-3C illustrate exemplary views of a part of a user interface of a mining vehicle for managing light setups of a mining vehicle, according to an example embodiment.

FIG. 4 illustrates an example of a layout of lights of a mining vehicle, according to an example embodiment.

FIG. 5 illustrates an example of a dashboard of a mining vehicle comprising a plurality of light mode switches, a display and a user input device, according to an example embodiment.

FIG. 6 illustrates an example of a flow diagram of controlling lights of a mining vehicle, according to an example embodiment.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of operations for constructing and operating the example. However, the same or equivalent functions and sequences may be accomplished by different examples.

Working conditions in mines may vary depending on the site. For example, mine tunnels may be formed through different rock types and have varying shapes. The different rock types may affect behavior of light in the mine, for example, black rock and white limestone reflect the lights of the mining vehicle differently from the walls of the mine. Further, the same mining vehicle may be operated by different users with different preferences for the lighting. One user may prefer more lighting and visibility for working than another. Sets of lights of different light modes of the mining vehicles may be fixed, wherein a light control of the mining vehicles does not allow modifications to the sets of lights by the users. Therefore, the users may have to add additional lights, such as work lights, operable with separate switches due to not being able to utilize the lights of the mining vehicle appropriately at all times. For example, the users may have to add additional lights to illuminate sides of the mining vehicle during transportation of load. The additional side lights may be desired during the transportation in order to avoid dazzling a driver of another mining vehicle coming behind the mining vehicle, which could happen when using normal work lights of the mining vehicle.

According to an example embodiment, a user is able to customize a light profile determining which light or lights are to be activated in different light modes of a mining vehicle. One or more customized lights profiles may be stored on the mining vehicle in addition to a factory-set light profile. The customized light profiles may be associated to different users such that a same light mode switch of the mining vehicle may activate different lights for the different users. The user may select between the one or more modified light profiles and the factory-set light profile. The light profile modified by the user may be automatically executed in response to detecting the user is operating the mining vehicle. For safety, at least some of the light selections may be fixed. The modified light profile may be restored to factory settings by the user. For example, if the mining vehicle is transferred to another mine, it may be desired to reset the previous mine-specific modifications.

An example embodiment improves visibility and operability of the mining vehicle in mines compared to conventional solutions where the user can only select between fixed light setups of the light modes configured by a manufacturer of the mining vehicle. Safety may be ensured by locking some of the settings. For example, when the user selects a reversing gear, at least two reversing lights may always be activated without a possibility to change the setting. In dark, diverse mine site conditions, the possibility to modify the lighting of the mining vehicle provides increased safety and usability of the lights of the mining vehicle. In addition, there may be no longer a need to install additional lights to the mining vehicle to achieve the desired lightings. All desired changes in the lighting may be achieved by changing the light settings from a user interface associated with light control of the mining vehicle.

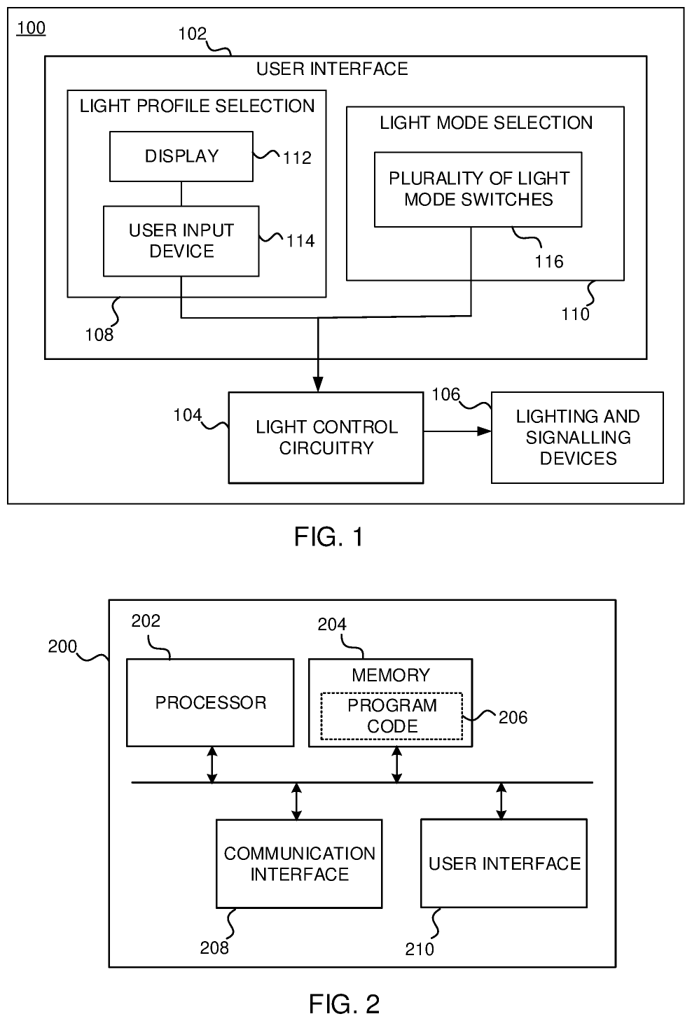

FIG. 1 illustrates an example of a block diagram of a mining vehicle 100 configured to control lights of the mining vehicle based on a light profile and a light mode selected by a user, according to an example embodiment.

In general, different types of wheeled mining vehicles are used in mines and at other work sites. The mining vehicle 100 may be, for example, a wheel loader, a transport vehicle or dumper, a rock drilling rig, a bolting or reinforcing vehicle or a measuring vehicle. The mining vehicles are provided with one or more mine working devices for executing mine work task at the work site.

The mining vehicle 100 comprises a user interface 102 configured to enable a user of the mining vehicle 100 to operate the mining vehicle 100. The user interface 102 may comprise a dashboard, for example, with a steering wheel, a gearshift, an instrument cluster and one or more light control panels 108, 110. The dashboard usually locates directly ahead of a driver of the mining vehicle beneath a front window of the mining vehicle. The light control panel(s) 108, 110 may comprise means for selecting a light profile and means for selecting a light mode of the mining vehicle.

The light control panel 110 of the user interface 102 comprises a plurality of switches configured to enable the user to select a light mode of the mining vehicle. As illustrated in FIG. 5, the light mode switches 116 may be typical vehicle light switches located at the dashboard 500 of the mining vehicle and configured to activate external lighting of the vehicle. The light mode switches 116 may comprise, for example, switches for a low beams light mode, a high beams light mode, a work light mode and a reversing light mode. The reversing light mode may be activated automatically in response to the user selecting a reversing gear with a gearshift. The gearshift may be a lever coupled to a switch configured to activate reversing lights when the reversing gear is selected. The user may be able to manually select one of the high beams light mode, the low beams light mode or the work light mode from the light control panel 110. The light mode switch 116 may comprise, for example, a push button switch, a rotative switch, a lever switch, or a multifunction switch located on the steering wheel of the mining vehicle 100. In general, the light mode is associated to a specific set of lights which will be activated in response to an activation of the light mode. The low beams light mode switch, the high beams light mode switch, the work light mode switch and the reversing light mode switch may be standard switches in the mining vehicle configured for activation of the corresponding factory-set light modes.

The plurality of light mode switches 116 are coupled to a light control circuitry 104 configured to control each lighting and signaling device 106 of the mining vehicle 100. The lighting devices may be configured for lighting purposes and the signaling devices may be configured to indicate a presence, dimensions and intended maneuvers of the mining vehicle to others. The lighting devices may comprise headlights attached to a front of the mining vehicle, such as low beams and high beams, and one or more work lights which location may depend on their lighting purpose and the type of the mining vehicle.

The light control panel 108 of the user interface 102 may comprise a display 112. The display and the user input device 114 may be located at the dashboard, as illustrated in FIG. 5. The display 112 may be coupled to a user input device 114. The user input device 114 may comprise one or more control buttons, a rotative control knob, a touch screen, or the like. In an embodiment, the display 112 and the user input device 114 may be configured in a single device, such as a touch screen display. In an embodiment, the light control panel 108 may communicate with a mobile device of the user to enable the user to operate the light control panel 108 via the mobile device. In an embodiment, the mobile device of the user may comprise the light control panel 108. In an embodiment, at least one of the light control panel 108 or the light control circuitry 104 may be configured to communicate with a remote automation system of the work site to enable the user to operate light functions of the mining vehicle from a remote location. Hence, the user may not have to locate in a cabin of the mining vehicle in order to be able to select or modify the light profile. The user input device 114 may be configured to enable the user to navigate information provided via the display 112. The information may be associated to lighting and signaling devices 106 of the mining vehicle 100. Based on the displayed information, the user may customize the light profile of the mining vehicle 100. The light profile may indicate which lights of the mining vehicle are activated at a certain light mode. Information associated to one or more light profiles may be received and stored at the light control circuitry 104 of the mining vehicle 100 configured to communicate with the light control panel 108. The light control circuitry 104 may cause display of locations of the lighting and signaling devices at the mining vehicle 100 to the user via the display 112, and receive information on which of the lighting and signaling devices 106 are turned on at which light modes based on user inputs received via the user input device 114 coupled to the display 112.

The light control circuitry 104 may receive inputs from the user input device 114 and the plurality of light mode switches 116 to determine which lights of the mining vehicle to activate. Inputs from the user input device 114 indicate the light profile and at least one of the inputs from the plurality of light mode switches 116 indicate the light mode. The light profile may comprise a different light setup for each of the light modes. In an embodiment, the user may switch between two or more light profiles via the user input device 114. One light mode may be associated to more than one different light setups based on the light profiles. Hence, when the user switches on for example the low beams light mode with one of the light mode switches, the outcome may depend on the selected light profile. In an embodiment, the light profile may be associated to a specific user or a user group such that different sets of lights may be activated for different users from the same light mode switch.

FIG. 2 illustrates an example of an apparatus 200 configured to practice one or more example embodiments. The apparatus 200 may be a computing device, for example a light control module of a mining vehicle. The light control module may comprise the light control circuitry 104. In an embodiment, the apparatus 200 may comprise the mining vehicle 100. Although the apparatus 200 is illustrated as a single device it is appreciated that, wherever applicable, functions of the apparatus 200 may be distributed to a plurality of devices.

The apparatus 200 may comprise at least one processor 202. The at least one processor may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 200 may further comprise at least one memory 204. The memory 204 may be configured to store, for example, computer program code or the like, for example operating system software and application software. The memory may comprise one or more volatile memory devices, one or more non-volatile memory devices, and/or a combination thereof. For example, the memory may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 200 may further comprise communication interface 208 configured to enable apparatus 200 to transmit and/or receive information, to/from other apparatuses. The communication interface may be configured to provide at least one wireless radio connection, such as for example a 3GPP mobile broadband connection (e.g. 3G, 4G, 5G). However, the communication interface may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 208 may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

The apparatus 200 may further comprise a user interface 210 comprising at least one input device and an output device. The input device may take various forms such a keyboard, a touch screen, or one or more embedded control buttons. The output device may for example comprise a display, a speaker, a vibration motor, or the like. The user interface 210 may be, for example, the user interface 102.

When the apparatus 200 is configured to implement some functionality, some component and/or components of the apparatus, such as for example the at least one processor and/or the memory, may be configured to implement this functionality. Furthermore, when the at least one processor is configured to implement some functionality, this functionality may be implemented using program code 206 comprised, for example, in the memory 204.

The functionality described herein may be performed, at least in part, by one or more computer program product components such as software components. According to an embodiment, the control device comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (CPUs).

The control device 100 comprises means for performing at least one method described herein. In one example, the means comprises the at least one processor, the at least one memory including program code configured to, when executed by the at least one processor, cause the apparatus to perform the method.

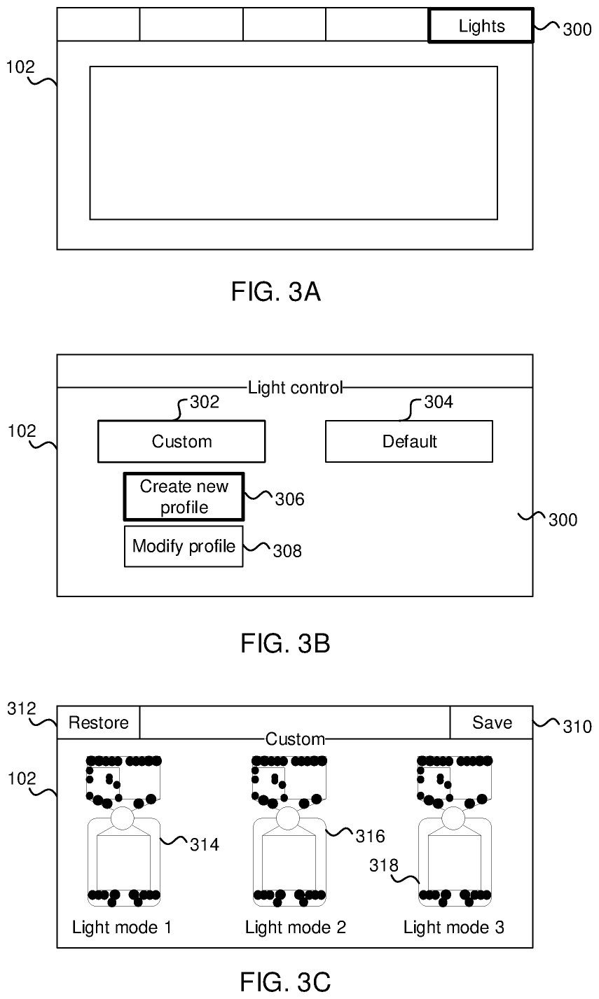

FIGS. 3A-3C illustrate exemplary views of a part of a user interface 102 of a mining vehicle for managing light setups of a mining vehicle, according to an example embodiment. The user interface 102 is configured to receive inputs from the user and display information for the user, as previously described.

Initially, at FIG. 3A, the user interface 102 may represent, for example via the display 112, a home screen with a menu bar comprising a tab for light control 300. The user may select, modify and create a light profile by opening the light control tab 300. The light control tab 300 may comprise a list of available light profiles 302, 304, as shown in FIG. 3B. The available light profiles 308, 310 may comprise light profiles stored and retrieved from a memory associated to the light control circuitry 104. The available light profiles may be associated to a specific user or a user group and the retrieved light profiles may depend on identification of the user. The user interface 102 may be configured to request user credentials for the light control. The different light profiles may be associated, for example, to different individual drivers, maintenance personnel, or work assignments. The list may comprise, for example, at least one custom light profile 302 and a default factory-set light profile 304. The light control tab 300 may further comprise a button for creating a new light profile 306. The light control tab may comprise a button for modifying a selected existing custom light profile 308.

When the user selects to create or modify a light profile, the user interface 102 may be configured to display one or more layouts of the lights of the mining vehicle 314, 316, 318, as shown in FIG. 3C. The layouts may be shown in association to each light mode of the mining vehicle such that the user is able to select which lights will be activated in response to the user initiating a specific light mode. In other words, the user may customize the light control according to his needs and preferences and determine what kind of lighting is provided by which light mode switch of the mining vehicle. Hence, the user is able to perceive an impact of his light choices to the lighting provided by the mining vehicle at one glance. The same light mode switch may activate different sets of lights depending on the selected light profile. Conveniently, the modified light profile is associated to operation of the same light mode switches as the default factory-set light profile to which users are accustomed to. The user interface may provide options 310, 312 for the user to confirm or revert the made light selections. The user interface 102 may provide a possibility to save the created or modified light profile to the memory. In addition, the user may restore the light profile as set at the factory.

Thus, the user interface 102 may provide a step-by-step guidance for managing lights of the mining vehicle by the user. First, the user may initiate the light setup by selecting the light control. In response, information about available light profiles is retrieved from the memory and displayed for the user. Further, the user is provided an option to create or modify a light profile. Lastly, information about each light of the mining vehicle is displayed to the user and the user is able to select which of the lights are activated in which light mode of the mining vehicle. In response to inputs from the user, a light profile customized by the user may be stored to the memory. The user may select any of the plurality of light profiles displayed at the user interface to initiate activation of the lights according to the light profile and selected light mode. The user interface provides a user-friendly and simple manner to control the light setups of different light modes of the mining vehicle.

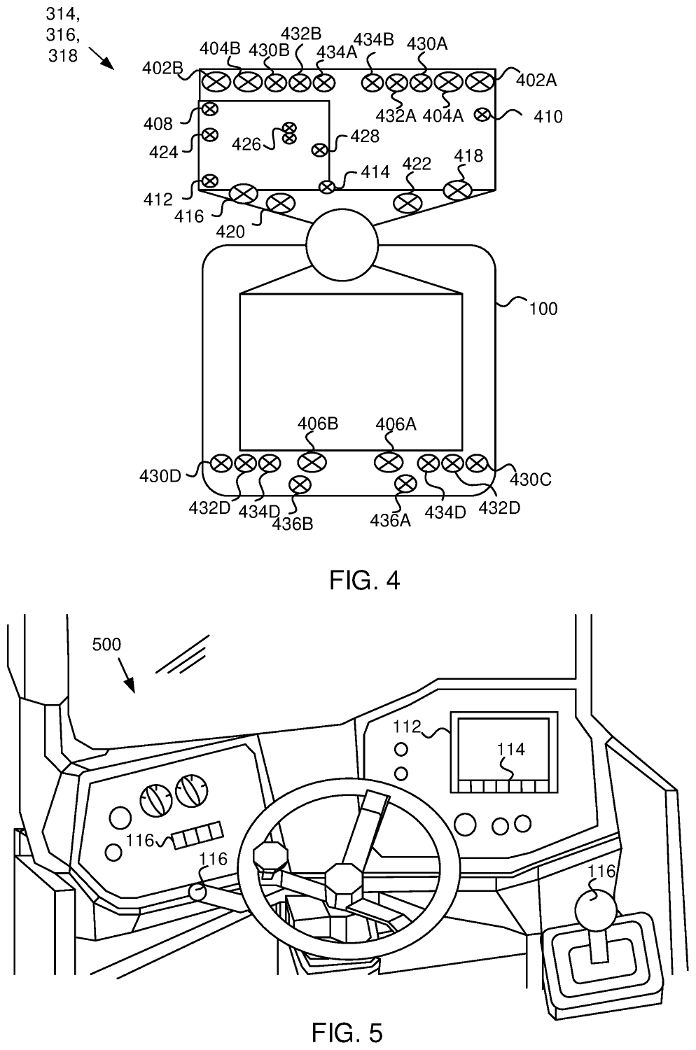

FIG. 4 illustrates an example of the layout of lights 314, 316, 318 of a mining vehicle 100, according to an example embodiment.

Main lights of the mining vehicle 100 may comprise a pair of low beams 402A, 402B; a pair of high beams 404A, 404B; a pair of reversing lights 406A, 406B; a front left cabin corner light 408, a front right cabin corner light 410, a rear left cabin corner light 412, at least one loading light 414, an upper left articulation light 416, an upper right articulation light 418, a lower left articulation light 420 and a lower right articulation light 422. The lights of the mining vehicle may further comprise a plurality of indicator and safety lights, such as a doorstep light 424, cabin interior lights 426, a warning beacon 428, brake lights 430A, 430B, 430C, 430C; red driving direction lights 432A, 432B, 432C, 432C; green driving direction lights 434A, 434B, 434C, 434C; and retarder lights 436A, 436B. The user may select from the layout 314, 316, 318 one or more lights to be activated in the light mode associated with the layout 314, 316, 318. Display of the layout of the lights may provide information for the user about the number, functionality and locations of the lights at the mining vehicle and, thus, enables the user to make precise and meaningful light control decisions.

In an embodiment, the user may create a custom light profile by modifying light setups corresponding to a factory-set light profile by changing one or more of the lamps to be activated in one or more of the light modes. Hence, the user may not have to select each lamp separately to create the light profile of his choice, but the user can use the factory-set light profile as a basis for the custom light profile. In an embodiment, the custom light profile may comprise additional control features, such as an inclination level of a light or settings of cornering lights. The custom light profile may be associated to the user and activated each time the user is identified. Alternatively, the custom profile may be shown on the list of the light profiles and the user may manually select which of the light profiles he wants to use.

The main lights of the mining vehicle may be divided into groups. For example, low beams 402A, 402B, high beams 404A, 404B and reversing lights 406A, 406B may be activated in pairs. The rest of the lights 408, 410, 412, 414, 416, 418, 420, 422 may be configurable individually. For example, if the user selects one of the low beams 402A or 402B to be activated in a specific light mode, both of the low beams 402A, 402B will be automatically selected. Hence, selection of one lamp in the group causes selection of each lamp in the group. This may improve user experience as the user does not need to select each lamp with the same functionality one by one.

The modifications may be restricted. At least one of the light profiles may be permanent. One of the light profiles may comprise fixed factory-set light selections for the light modes. Some light selections may be pre-set and fixed for each light profile. For legal and safety reasons, the reversing lights may be always selected for reversing light mode. Further, activation of some of the indicator lights may be fixed for each of the light modes, or they may be independent of the light modes. For example, retarder and brake lights may be always operational.

For example, a low beams light mode of the factory-set light profile may comprise the pair of low beams 402A, 402B, the front right and front left cabin corner lights 408, 410, and the lower left and lower right articulation lights 420, 422. A high beams light mode of the factory-set light profile may comprise the pair of high beams 404A, 404B, the pair of low beams 402A, 402B, the front right and front left cabin corner lights 408, 410, and lower left and lower right articulation lights 420, 422. A work light mode of the factory-set light profile may comprise the rear left cabin corner light 412, the at least one loading light 414, the upper left and right articulation light 416, 418, and the lower left and lower right articulation lights 420, 422. A reversing light mode of the factory-set light profile may comprise the pair of the reversing lights 406A, 406B, the front right and front left cabin corner lights 408, 410, the rear left cabin corner light 412, the at least one loading light 414, the upper left and right articulation light 416, 418, and the lower left and lower right articulation lights 420, 422.

The user may customize the factory-set profile, or create another light profile, by adding or removing one or more lights to be activated at one or more of the light modes. In an example embodiment, the user may select one or more of the lights typically activated in the factory-set work light mode to be activated also at another light mode(s). The user may, for example, create a light profile comprising the corresponding set of lights as in the factory-set light profile and further add the articulation lights 416, 418, 420, 422 to the set of lights to be activated in the high and low beams light mode. The articulation lights may help the user to better perceive an area around the mining vehicle while ensuring that blinding or dazzling of a driver coming from behind of the mining vehicle may be prevented.

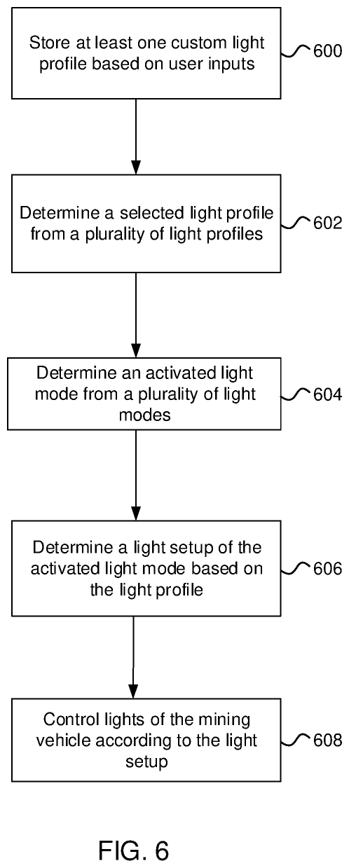

FIG. 6 illustrates an example of a flow diagram of controlling lights of a mining vehicle, according to an example embodiment. The procedure of FIG. 6 may be executed by the apparatus 200.

At 600, at least one custom light profile may be stored based on user inputs. The light profile may comprise a plurality of light setups, wherein each light setup is associated to a different light mode of the mining vehicle. The light modes may be predetermined and activated from light mode switches of the mining vehicle. The light mode may be associated to the user who created the light profile. The light profile may be stored to a light profile database comprising information of each light profile set for the mining vehicle. The custom light profile may be determined based on the user input received via a user interface. The user interface may comprise an input device such as a touch screen embedded to the mining vehicle or any other means for receiving the user inputs.

At 602, a light profile selected among a plurality of light profiles may be determined. The selected light profile may be determined based on a user input received via the user interface in response to a list of the plurality of light profiles displayed to the user via the user interface. The apparatus may be triggered to cause display of the list of the plurality of light profiles in response to receiving a request for light management from the user interface. In an embodiment, the apparatus may be configured to receive an authentication of a user or a user group, and cause display of light profiles associated to the user or user group for the selection. In an embodiment, the custom light profile associated to the user may be automatically determined as the selected light profile.

At 604, it is determined which light mode of a plurality of light modes of the mining vehicle is currently activated. The activated light mode may be determined based on a signal received from at least one light mode switch of the mining vehicle.

At 606, a light setup of the activated light mode is determined based on the selected light profile. The apparatus may check from the currently activated light profile which lights are to be turned on for the activated light mode.

At 608, the lights of the mining vehicle are controlled according to the light setup. The apparatus may execute light control instructions of the light profile by causing different lights of the mining vehicle to turn on or off when the light modes are switched from one to another via the light mode switches.

Hence, a flexible and versatile light control system for a mining vehicle is provided. Utility of lights of the mining vehicle may be increased. Further, modification operations for the lighting are made simple and intuitive for the users.

Further features of the method(s) directly result for example from functionalities of the apparatus described throughout the specification and in the appended claims and are therefore not repeated here. Different variations of the method(s) may be also applied, as described in connection with the various example embodiments.

An apparatus may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first’ or ‘second’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus for controlling lights of a mining vehicle, the apparatus being configured to:
determine a customized light profile based on user inputs, the light profile indicating which lights of the mining vehicle are to be activated in each different light mode of a plurality of light modes of the mining vehicle;
determine which light mode of the plurality of light modes is to be activated based on a signal received from at least one light mode switch of the mining vehicle; and
control the lights of the mining vehicle based on the light mode in accordance with the customized light profile.

2. The apparatus of claim 1, wherein the apparatus is further configured to:
store a plurality of light profiles having at least one customized light profile;
cause a display of a list of the plurality of light profiles to a user;
obtain an indication of a selected light profile from the list of the plurality of light profiles based on an input from the user; and
control the lights of the mining vehicle based on the light mode in accordance with the selected light profile.

3. The apparatus of claim 1, wherein the customized light profile is associated to a specific user or a user group, and wherein the lights of the mining vehicle are controlled in accordance with the customized light profile associated to the user or user group in response to obtaining an identification of the user or user group.

4. The apparatus of claim 1, wherein the apparatus is further configured to cause display of at least one layout of the lights of the mining vehicle to the user, wherein the customized light profile is determined based on the user inputs indicating one or more lights from the layout to be activated in one or more light modes of the plurality of light modes.

5. The apparatus of claim 1, to wherein the at least one light mode switch includes a work light mode switch, a low beams light mode switch, a high beams light mode switch and a reversing light mode switch of the mining vehicle.

6. The apparatus of claim 1, the apparatus being further configured to set at least one fixed light selection associated to at least one light mode of the plurality of light modes to the customized light profile.

7. The apparatus of claim 1, wherein the lights of the mining vehicle include a plurality of light groups, and a selection of one light in the light group for the customized light profile causes selection of each light in the light group to be activated in the associated light mode.

8. A mining vehicle comprising the apparatus of claim 1.

9. A method for controlling lights of a mining vehicle, the method comprising:
determining a light profile based on user inputs, the light profile indicating which lights of the mining vehicle are activated in different light modes of a plurality of light modes of the mining vehicle;
determining which light mode of the plurality of light modes is to be activated based on a signal received from at least one light mode switch of the mining vehicle; and
controlling the lights of the mining vehicle based on the light mode in accordance with the customized light profile.

10. The method of claim 9, further comprising:
storing a plurality of light profiles including at least one customized light profile;
causing a display of a list of the plurality of light profiles to a user;
obtaining an indication of a selected light profile from the list of the plurality of light profiles based on an input from the user; and
controlling the lights of the mining vehicle based on the light mode in accordance with the selected light profile.

11. The method of claim 9, wherein the at least one customized light profile is associated to a specific user or a user group and wherein the lights of the mining vehicle are controlled in accordance with the customized light profile associated with the user or user group in response to obtaining an identification of the user or user group.

12. The method of claim 9, further comprising causing display of at least one layout of the lights of the mining vehicle to the user, wherein the customized light profile is determined based on the user inputs indicating one or more lights from the at least one layout to be activated in one or more light modes of the plurality of light modes.

13. The method of claim 9, further comprising setting at least one fixed light selection associated to at least one light mode of the plurality of light modes to the customized light profile.

14. A computer program comprising program code configured to cause performance of the method according to claim 9, when the computer program is executed on a computer.

15. A computer readable medium comprising the computer program of claim 14.
